(19) United States
(12) Patent Application Publication
(10) Pub. No.: US 2024/0188656 A1
(43) Pub. Date: Jun. 13, 2024

(54) MASK FILTER INCLUDING COUPLING PORTIONS

(71) Applicant: KOREATECH Co., Ltd., Seoul (KR)

(72) Inventor: Dong Yol LEE, Seoul (KR)

(73) Assignee: KOREATECH Co., Ltd., Seoul (KR)

(21) Appl. No.: 18/286,038

(22) PCT Filed: Apr. 9, 2021
(86) PCT No.: PCT/KR2021/004537

§ 371 Date: Oct. 6, 2023

(30) Foreign Application Priority Data
Apr. 7, 2021 (KR) 10-2021-0045430

(51) Int. Cl. A41D 13/11

(52) U.S. Cl. CPC A41D 13/11

(57) ABSTRACT

A mask filter including coupling portions is disclosed. More particularly, a mask filter including detachable coupling portions added to a portion of the mask filter is disclosed.

### TECHNICAL FIELD

This application claims the benefit of Korean Patent Application No. 2021-0045430 filed on Apr. 7, 2021 with the Korean Intellectual Property Office, the disclosure of which is incorporated herein by reference in its entirety.

The present invention relates to a mask filter including coupling portions. More particularly, the present invention relates to a mask filter including detachable coupling portions added to a portion of the mask filter.

### BACKGROUND ART

Masks, which are a product related to diseases, have been limitedly used. Masks have been used as an auxiliary means for preventing diseases of an individual from propagating to others or preventing infection from others. The cases in which masks are worn in order to block yellow dust and fine dust have become more frequent; however, this is also for preventing diseases.

Due to the coronavirus disease 2019 (COVID-19) pandemic, awareness about masks has abruptly changed. Masks have been treated with respect to such an extent that masks were in short supply, and the fact that a disease prevention effect is great even though only masks are used has been socially learned. Experiences in which people spend most of the day while wearing masks have been widely shared. A negative point of view that faces are covered by wearing masks has been alleviated without distinction between East and West.

Masks have been used as daily necessities, such as glasses. It seems to be that all families continuously stock at least a minimum quantity of masks. It will be very natural to wear masks for pollen or yellow dust in spring, automobile exhaust fumes in summer, and mild cold in winter. Wearing masks will also be very natural, much like wearing glasses is normal.

Grade and usage of masks are classified based on the leak rate thereof. The leak rate of masks used in Korea is measured according to a leak rate test method described in National Institute of Food and Drug Safety Evaluation “Guidelines about standards of health masks (Guidelines for the Public)” Guidelines-0349-04.

Even though a certain mask has an approved leak rate, the actual leak rate of the mask may be changed depending on the size of the face of a user who wears the mask and the length of a string fixed to each ear of the user.

The inventors of the present application compared the leak rate of a mask manufactured for adults without adjustment in length of a string of the mask with the leak rate of the mask in which the length of the mask including the strings was adjusted to 102% of the length of the face. It was revealed that the latter case had a minimum leak rate of 25% to a maximum leak rate of 83% less than the former case. That is, the length of the string of the mask must be adjusted in order to reduce the leak rate, through which it can be seen that it is possible to achieve the original purpose of wearing a mask. The facial length mentioned herein, which is a facial length measured using Morpheus, is the distance between the left ear and the point under the nose of the user and between the point under the nose and the right ear of the user.

Even though the leak rate can be increased by adjusting the length of the string of the mask, the size of a mask designed along a curve of the face, exactly a mask filter, also has an influence on the leak rate. Since facial sizes are different from each other according to people of all ages and both sexes, it is substantially impossible to provide customized masks to all users. There are a few mask filters of predetermined sizes or curved mask filters as masks currently sold on the market.

### DISCLOSURE

### Technical Problem

The present invention has been made in view of conventional problems, and it is an object of the present invention to provide a mask filter configured such that the size of the mask filter is adjustable by users so as to correspond to facial sizes according to people of all ages and both sexes.

Non-limiting examples of the mask may be a double folding mask, a foldable mask, a cup type mask, and an anti-droplet mask.

A mask filter mentioned throughout the specification of the present application corresponds to a mask main body excluding strings. In the present invention, the corresponding portion is referred to as a mask filter or a filter.

### Technical Solution

In order to accomplish the above object, the present invention provides a mask filter including a filter main body disposed in front of the face of a user, an upper filter surface fixed along at least a portion of an outer periphery of an upper part of the filter main body, fixed in a state of being spaced apart downwards from at least a portion of the outer periphery of the upper part of the filter main body, or configured to cover at least a portion of the nose of the user and the skin therearound as the result of the upper part of the filter main body being bent, and a lower filter surface fixed along at least a portion of an outer periphery of a lower part of the filter main body, fixed in a state of being spaced apart upwards from at least a portion of the outer periphery of the lower part of the filter main body, or configured to cover at least a portion of each jaw of the user and the skin therearound as the result of a lower surface of the filter main body being bent, wherein

one or more first coupling portions additionally coupled to the filter main body are provided at opposite sides of at least one of the upper filter surface and the lower filter surface, the first coupling portions being configured to have a detachable coupling structure.

In addition, the present invention provides a mask filter including a filter main body disposed in front of the face of a user, an upper filter surface fixed along at least a portion of an outer periphery of an upper part of the filter main body, fixed in a state of being spaced apart downwards from at least a portion of the outer periphery of the upper part of the filter main body, or configured to cover at least a portion of the nose of the user and the skin therearound as the result of the upper part of the filter main body being bent, and a lower filter surface fixed along at least a portion of an outer periphery of a lower part of the filter main body, fixed in a state of being spaced apart upwards from at least a portion of the outer periphery of the lower part of the filter main body, or configured to cover at least a portion of each jaw of the user and the skin therearound as the result of a lower surface of the filter main body being bent, wherein

one or more second coupling portions additionally coupled to the filter main body are provided at the middle of at least one of the upper filter surface and the lower filter surface, the second coupling portions being configured to have a detachable coupling structure.

In addition, the present invention provides a mask filter including a filter r main body disposed in front of the face of a user, a central portion of the filter main body being folded, wherein the filter main body includes a left main body and a right main symmetrical with each other and a joining portion, at which corresponding ends of the left main body and the right main body are coupled to each other by fusion after overlapping each other, and third coupling portions configured to have an additionally detachable coupling structure are added to at least one of an upper part and a lower part of the filter main body, among peripheries of the joining portion. At this time, the third coupling portions may be coupled to each other as the result of coupling between the left main body and the right main body or overlapping of the upper part or the lower part of the filter main body, independent of the joining portion.

In addition, the present invention provides a mask filter including a filter main body disposed in front of the face of a user, a portion configured to be folded in a horizontal direction being added to the filter main body, wherein one or more fourth coupling portions configured to allow parts of the filter main body to be coupled to each other are provided at at least one of a left upper end, a left lower end, a right upper end, and a right lower end of the filter main body, the fourth coupling portions being configured to have a detachable coupling structure.

The degree to which the upper filter surface and the lower filter surface are separated from the filter main body may be changed depending on coupling or detachment between the first coupling portions and/or the second coupling portions according to the present invention, and therefore it is possible to correspond to various facial sizes. In addition, the substantial size of the filter main body may be changed depending on coupling or detachment between the third coupling portions and the fourth coupling portions according to the present invention, and therefore it is possible to correspond to various facial sizes.

The first coupling portions to the fourth coupling portions may be detached by a user. The user may detach desired ones of the first coupling portions to the fourth coupling portions so as to match the size of their face for use.

Non-limiting examples of the detachable coupling structure may be at least one selected from the group consisting of fusion having a peel strength of 500 (g/25 mm) or less at 90 degrees based on SUS, Velcro tape, snap buttons, fitting, clips, magnetic force, sewing, buttons, couplers, tongs, adhesion, cohesion, and elastic coupling.

The first coupling portions of the upper filter surface and the second coupling portions of the lower filter surface may be disposed along the outer periphery of the upper filter surface and the outer periphery of the lower filter surface, respectively. The third coupling portions and the fourth coupling portions may also be disposed along the outer periphery of the filter main body.

Wrinkles may be formed around the first coupling portions to the fourth coupling portions.

In addition, the present invention may provide all possible combinations of the above solving means.

### Advantageous Effects

The present invention provides a mask filter including coupling portions, wherein detachment of the coupling portions is adjusted so as to correspond to the face of an individual user, whereby it is possible to provide a mask filter having a low leak rate and excellent wearing sensation. In addition, a process of adding the coupling portions may be configured by modifying only some of a conventional process while the conventional process is basically applied as is. Consequently, addition of the above construction is easy and economical. Meanwhile, variously sized mask filters corresponding to sizes and shapes of faces of users are not provided, whereby small variety production is achieved, and therefore a possibility of occurrence of surplus products is low. This is also very desirable in environmental terms in that resource utilization is more effective and it is possible to reduce mask filter waste.

### DESCRIPTION OF DRAWINGS

FIG. 1 is a perspective view of a conventional double folding mask.

FIG. 2 is an illustration of first coupling portions according to the present invention.

FIG. 3 is an illustration of second coupling portions according to the present invention.

FIG. 4 is a perspective view of a conventional foldable mask.

FIG. 5 is an illustration of third coupling portions according to the present invention.

FIG. 6 is a perspective view of a conventional anti-droplet mask.

FIG. 7 is an illustration of fourth coupling portions according to the present invention.

### BEST MODE

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of functions known and configurations incorporated herein will be omitted when the same may obscure the subject matter of the present invention.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, the present invention will be described in detail through the embodiments. However, the embodiments are provided in order to illustratively describe the present invention, and the scope of the present invention is not limited by the embodiments. The embodiments of the present invention will be described hereinafter with reference to the accompanying drawings.

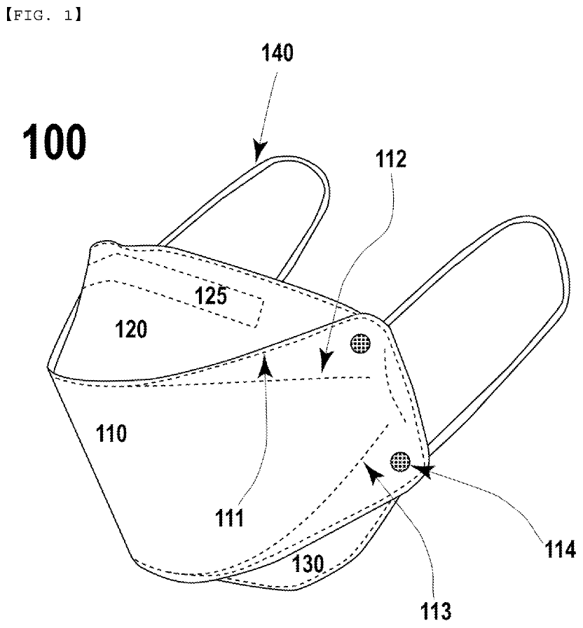

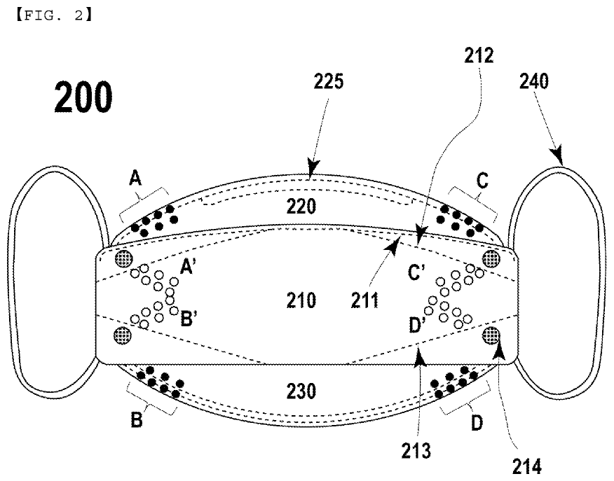

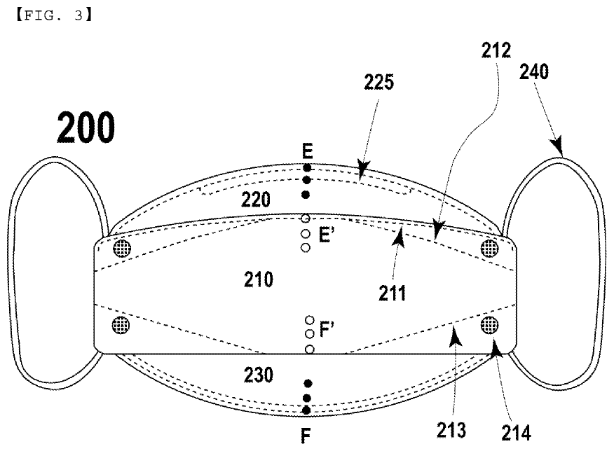

FIG. 1 is a perspective view of a conventional double folding mask, FIG. 2 is an illustration of first coupling portions according to the present invention, and FIG. 3 is an illustration of second coupling portions according to the present invention.

Referring to FIGS. 1 to 3, the double folding mask 100 or 200 includes a filter main body 110 or 210 disposed in front of the face of a user, an upper filter surface 120 or 220 fixed along at least a portion of an outer periphery of an upper part of the filter main body 110 or 210, fixed in a state of being spaced apart downwards from at least a portion of the outer periphery of the upper part of the filter main body 110 or 210, or configured to cover at least a portion of the nose of the user and the skin therearound as the result of the upper part of the filter main body 110 or 210 being bent, and a lower filter surface 130 or 230 fixed along at least a portion of an outer periphery of a lower part of the filter main body 110 or 210, fixed in a state of being spaced apart upwards from at least a portion of the outer periphery of the lower part of the filter main body 110 or 210, or configured to cover at least a portion of each jaw of the user and the skin therearound as the result of a lower surface of the filter main body 110 or 210 being bent. The filter main body 110 or 210, the upper filter surface 120 or 220, and the lower filter surface 130 or 230 constitute a mask filter.

A nose fixing portion 125 or 225 configured to increase force of fixation with the nose may be additionally added to the upper filter surface 120 or 220.

A string 140 or 240 is added to the mask filter to constitute a double folding mask 100 or 200, which is generally used. The filter main body 110 or 210 is formed by stacking a plurality of porous substrates so as to have a multilayer structure and coupling the plurality of porous substrates to each other. A joining portion 111 or 211 of the filter main body 110 or 210 is a region at which the plurality of porous substrates is coupled to each other. The upper filter surface 120 or 220 and the lower filter surface 130 or 230 are manufactured in a similar process such that the same joining portion is formed along the outer periphery thereof.

String joining portions 114 or 214 for coupling with the string 140 or 240 are also added to the filter main body 110 or 210.

The filter main body 110 or 210 and the upper filter surface 120 or 220 are coupled to each other along an upper joining portion 112 or 212, and the filter main body 110 or 210 and the lower filter surface 130 or 230 are coupled to each other along a lower joining portion 113 or 213. In FIGS. 1 to 3, the upper filter surface 120 or 220 is fixed in a state of being spaced apart downwards from at least a portion of the outer periphery of the upper part of the filter main body 110 or 210, and the lower filter surface 130 or 230 is fixed in a state of being spaced apart upwards from at least a portion of the outer periphery of the lower part of the filter main body 110 or 210.

Referring to FIG. 2, in the mask filter according to the present invention, one or more first coupling portions A-A′, B-B′, C-C′, and D-D′ additionally coupled to the filter main body 210 are provided at opposite sides of at least one of the upper filter surface 220 and the lower filter surface 230, and the first coupling portions A-A′, B-B′, C-C′, and D-D′ have a detachable coupling structure.

Referring to FIG. 3, in the mask filter according to the present invention, one or more second coupling portions E-E′ and F-F′ additionally coupled to the filter main body 210 are provided at the middle of at least one of the upper filter surface 220 and the lower filter surface 230, and the second coupling portions E-E′ and F-F′ have a detachable coupling structure.

FIGS. 2 and 3 schematize only the double folding mask filter, and a portion configured to fix the double folding mask filter to the face is omitted. In the present invention, one or more first coupling portions located at positions corresponding to A-A′, B-B′, C-C′, and D-D′ or one or more second coupling portions located at positions corresponding to E-E′ and F-F′ are added to portions fused when the conventional double folding mask filter is manufactured. When A-A′, B-B′, C-C′, D-D′, E-E′, and F-F′ are coupled to each other, coupling may be performed between different regions, not symmetrical positions. When A-A′, B-B′, C-C′, D-D′, E-E′, and F-F′ are coupled to each other, coupling between one or more pairs is possible so as to correspond to the sizes of faces of various users. When the face is the smallest, the first coupling portions or the second coupling portions are not detached from each other. When the face is larger, more detachment is performed.

The filter main body 210 according to the present invention is disposed around the mouse of the user, the upper filter surface 220 is disposed around the nose of the user, and the lower filter surface 230 is disposed around the jaws of the user.

One or more first coupling portions A-A′, B-B′, C-C′, and D-D′ fixed to the filter main body 210 may be provided at opposite sides of the upper filter surface 220 and the lower filter surface 230, and the first coupling portions A-A′, B-B′, C-C′, and D-D′ may have a detachable coupling structure.

One or more second coupling portions E-E′ and F-F′ fixed to the filter main body 210 may be provided at the middles of the upper filter surface 220 and the lower filter surface 230, and the second coupling portions E-E′ and F-F′ may have a detachable coupling structure.

In FIGS. 2 and 3, the detachable coupling structure must be configured such that the coupling portions can be detached from each other without damage to the filter main body 210, the upper filter surface 220, and the lower filter surface 230. As an example, peel strength for one coupling is 500 (g/25 mm) or less at 90 degrees based on SUS. Another detachable coupling structure may be at least one selected from the group consisting of Velcro tape, snap buttons, fitting, clips, magnetic force, buttons, couplers, tongs, sewing, adhesion, cohesion, and elastic coupling. A range in which the upper filter surface can be disposed may be between tip-defining points and a lower end of the nasal bone. A method of coupling third coupling portions or fourth coupling portions may be identical to the method of coupling the first coupling portions or the second coupling portions.

In FIG. 2 or 3, A-A′, B-B′, C-C′, D-D′, E-E′, and F-F′ are marked as an example of regions that can be coupled to each other. Each of A, B, C, D, E, and F is marked with a plurality of points, and at least one thereof may become a coupling region. Coupling regions A, B, C, D, E, and F are coupled with corresponding coupling regions A′, B′, C′, D′, E′, and F′, respectively. When A-A′, B-B′, C-C′, D-D′, E-E′, and F-F′ are coupled to each other, coupling may be performed between different regions, not symmetrical positions.

A, B, C, and D are examples of the first coupling portions, and E and F are examples of the second coupling portions. When the filter is manufactured, the filter may be manufactured in the state in which coupling is performed at all of A, B, C, D, E, and F in the initial stage. Afterwards, a user may detach the coupling portions from each other so as to match their face.

The degree to which the upper filter surface and the lower filter surface are separated from the filter main body may be changed depending on coupling or detachment between the first coupling portions and/or the second coupling portions according to the present invention, and therefore it is possible to correspond to various facial sizes. The first coupling portions and/or the second coupling portions may be detached by a user. The user may detach desired ones of the first coupling portions and/or the second coupling portions so as to match the size of their face for use. This is equally applied to third coupling portions and fourth coupling portions, a description of which will follow.

When the first coupling portions and the second coupling portions are disposed along the outer peripheries of the upper filter surface 220 and the lower filter surface 230, strength in tight contact is high. Even though a portion of the upper filter surface 220 or the lower filter surface 230 is damaged at the time of detachment, therefore, there is no problem. In this case, tight contact with the face of the user is achieved by the remaining portion of the upper filter surface 220 or the lower filter surface 230, since the damaged portion of the upper filter surface or the lower filter surface is the outermost portion of the upper filter surface or the lower filter surface. In this case, the coupling portions disposed along the outer peripheries of the upper filter surface 220 and the lower filter surface 230, among examples of A-A′, B-B′, C-C′, D-D′, E-E′, and F-F′, correspond thereto.

The upper filter surface 220, the lower filter surface 230, or the filter main body 210, 410, or 610 may be provided with separate wrinkles formed at positions corresponding to the first coupling portions to the fourth coupling portions. The wrinkles may be curved along the contour line of the face, particularly the contour line of the jaws, not straight.

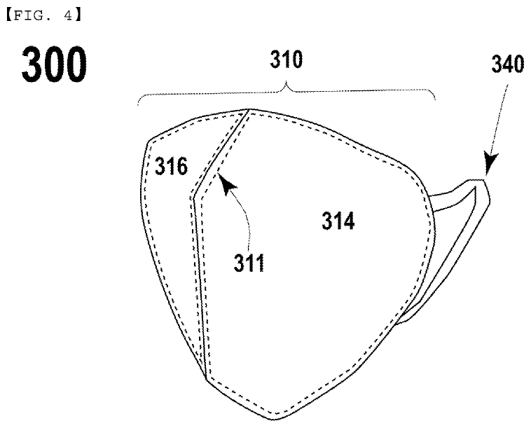

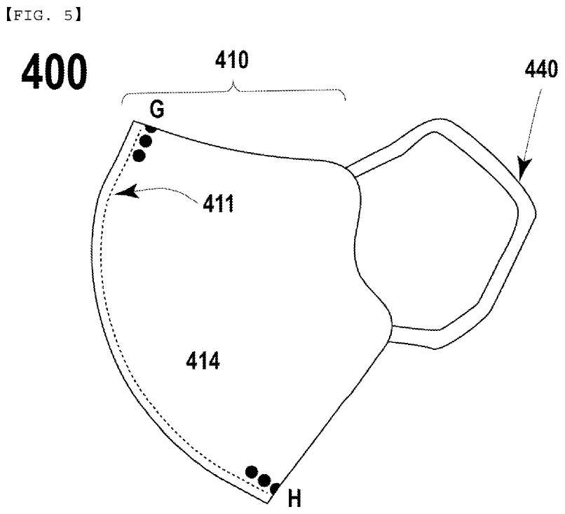

FIG. 4 is a perspective view of a conventional foldable mask, and FIG. 5 is an illustration of third coupling portions according to the present invention.

Referring to FIGS. 4 and 5, the foldable mask 300 or 400 includes a mask filter including a filter main body 310 or 410 disposed in front of the face of a user, a central portion of the filter main body being folded, wherein the filter main body 310 or 410 includes a left main body 314 or 414 and a right main body 316, which are symmetrical with each other, and a joining portion 311 or 411, at which corresponding ends of the left main body and the right main body are coupled to each other by fusion after overlapping each other.

Referring to FIG. 5, third coupling portions G and H configured to have an additionally detachable coupling structure are added to at least one of an upper part and a lower part of the filter main body 410, among peripheries of the joining portion 411.

At this time, the third coupling portions G and H may be coupled to each other as the result of coupling between the left main body 414 and the right main body or overlapping of the upper part or the lower part of the filter main body 410, independent of the joining portion 411.

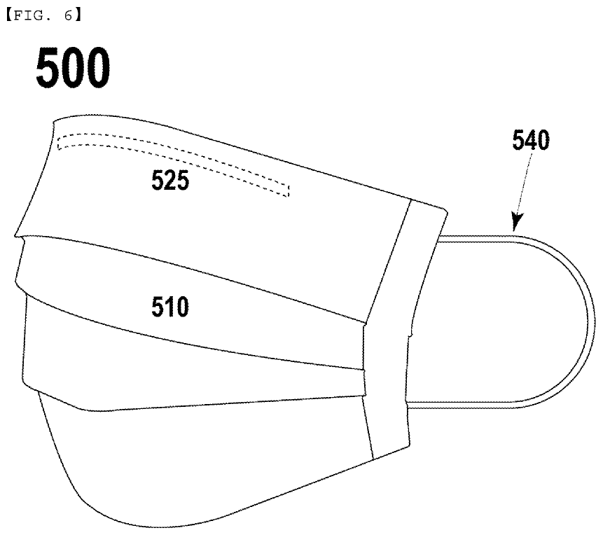

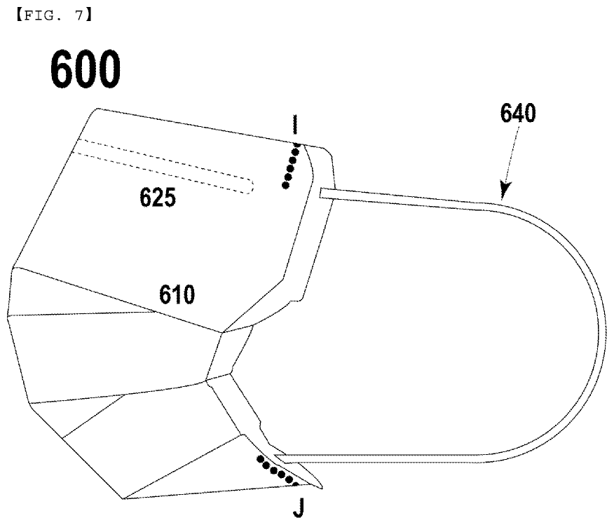

FIG. 6 is a perspective view of a conventional anti-droplet mask, and FIG. 7 is an illustration of fourth coupling portions according to the present invention.

Referring to FIGS. 6 and 7, the anti-droplet mask 500 or 600 includes a mask filter including a filter main body 510 or 610 disposed in front of the face of a user, a portion configured to be folded in a horizontal direction being added to the filter main body.

Referring to FIG. 7, in the mask filter, one or more fourth coupling portions I and J configured to allow parts of the filter main body to be coupled to each other are provided at at least one of a left upper end, a left lower end, a right upper end, and a right lower end of the filter main body 610, the fourth coupling portions I and J being configured to have a detachable coupling structure. One or more points constituting I are coupled to each other, and one or more points constituting J are coupled to each other.

### DESCRIPTION OF REFERENCE SYMBOLS

100, 200: Double folding masks
300, 400: Foldable masks
500, 600: Anti-droplet masks
110, 210, 310, 410, 510, 610: Filter main bodies
111, 211, 311, 411: Joining portions
112, 212: Upper joining portions
113, 213: Lower joining portions
114, 214: String joining portions
120, 220: Upper filter surfaces
125, 225, 525, 625: Nose fixing portions
130, 230: Lower filter surfaces
140, 240, 340, 440, 540, 640: Strings
314: Left main body
316: Right main body
A-A′, B-B′, C-C′, D-D′: First coupling portions
E-E′, F-F′: Second coupling portions
G, H: Third coupling portions
I, J: Fourth coupling portions

### INDUSTRIAL APPLICABILITY

The present invention relates to a mask filter including detachable coupling portions added to a portion of the mask filter, and therefore the present invention has industrial applicability.

1-2. (canceled)

3. A mask filter comprising a filter main body disposed in front of a face of a user, a central portion of the filter main body being folded, wherein
the filter main body comprises a left main body and a right main symmetrical with each other and a joining portion, at which corresponding ends of the left main body and the right main body are coupled to each other by fusion after overlapping each other, and
third coupling portions configured to have an additionally detachable coupling structure are added to at least one of an upper part and a lower part of the filter main body, among peripheries of the joining portion.

4. (canceled)

5. The mask filter according to claim 3, wherein the detachable coupling structure is at least one selected from a group consisting of fusion having a peel strength of 500 (g/25 mm) or less at 90 degrees based on SUS, Velcro tape, snap buttons, fitting, clips, magnetic force, sewing, buttons, couplers, tongs, adhesion, cohesion, and elastic coupling.

6. The mask filter according to claim 3, wherein the third coupling portions are disposed so as to abut at least one of an outer periphery of the upper filter surface, an outer periphery of the lower filter surface, and the outer periphery of the filter main body.

7. The mask filter according to claim 3, wherein wrinkles are formed around the third coupling portions.
